(19) United States
(12) Patent Application Publication
(10) Pub. No.: US 2003/0139192 A1
(43) Pub. Date: Jul. 24, 2003

(54) Multi-user mobile telephone station and a method of providing a multi-user mobile telephone station

(76) Inventors: Mazen Chmaytelli, San Diego, CA (US); Samir Khazaka, San Diego, CA (US)

Correspondence Address: Sarah Kirkpatrick, Manager, Intellectual Property Administration, QUALCOMM Incorporated, 5775 Morehouse Drive, San Diego, CA, 92121-1714, US

(21) Appl. No.: 10/167,748

(22) Filed: Jun. 10, 2002

Related U.S. Application Data
(60) Provisional application No. 60/349,916, filed on Jan. 18, 2002.

(51) Int. Cl. H04Q 7/20; H04B 1/38

(52) U.S. Cl. 455/463; 455/574

(57) ABSTRACT

A multi-user mobile telephone station, and a method of providing a multi-use mobile telephone station, are disclosed. The multi-user telephone station includes a handset having a key pad, a power-on switch, a display, and a controller coupled to the key pad and the display, a first memory location that stores a first feature set corresponding to a first user of the mobile telephone station, and a second memory location that stores a second feature set corresponding to a second user of the mobile telephone station. Upon powering-on of the handset, a log-in request is presented on the display, and, in response to the log-in request, the controller receives via the keypad a unique code that corresponds to one of at least the first user and the second user. In response to receipt of the unique code, the controller selects one of at least the first feature set or the second feature set and configures the mobile telephone station in accordance with the selected feature set. The handset is preferably a cellular telephone handset. The method includes providing a handset having a key pad and a power on switch, uniquely corresponding in at least one memory area of the handset a first feature set to a first user, and each of at least one secondary feature set to each additional user, activating by a user of a log-in display on the mobile station by powering on the handset, logging in by a user as a first user, as an additional user, or as an unknown user through the log-in display, and accessing by the user of the first feature set or the secondary feature set that uniquely corresponds to the user.

### RELATED APPLICATIONS

This application claims priority to U.S. Provisional Application No. 60/349,916, filed Jan. 18, 2002.

### BACKGROUND OF THE INVENTION

1. Field of the Invention

The present invention is directed generally to a method and apparatus for allowing multiple users on a telephone and, more particularly, to a multi-user mobile telephone station and a method of providing a multi-user mobile telephone station.

2. Description of the Background

The use of cellular telephones has recently experienced a dramatic increase, and that increase continues in part due to the expansion of persons in need of cellular services for safety, convenience, and peace of mind. For example, many parents want their children to carry cellular phones when the children are out of the home without the parent or parents, in contemplation of a safety emergency, and many businesses want business travelers related to those businesses to have access to cellular service for business updates and/or travel emergencies.

However, for a parent or business to grant telephone access to all parties involved would necessitate the purchase of enormous quantities of telephones, at great expense to the purchaser. Further, not all parties involved would need the same features on each party's individual telephone. For example, while a parent would like a child to call home in the instance of a flat tire during a date, that same parent likely would not wish the child to call large numbers of friends on the cellular telephone while the child was in the parents' home. Thus, recently developed telephone plans which place multiple telephones on one telephone bill are still subject to possible abuse, through use in circumstances for which access to the telephone was not intended.

Because of the aforementioned problems, families and businesses often elect to purchase only a single telephone, and grant the use to only the party that needs access at a given time. However, this granting of access only in certain circumstances does not prevent an abuse of the use of the telephone during the circumstances. For example, a child could be out on a date, and use the phone to make numerous calls to friends during the child's access time.

An additional issue arises in that, unless the parent or business tracks the possessor of the telephone at every moment, there is no way to tell what parties have engaged in any abuses of the telephone, without an admission from those abusing parties. Further, such abuses can lead to great additional expense to a business, and, without a method of preventing such abuses, cannot be remedied after the fact.

Therefore, the need exists for a method and apparatus that avoids the necessity of getting separate telephones for each party that necessitates telephone access, while still providing a manner of tracking and preventing abuses of access to the telephone.

### BRIEF SUMMARY OF THE INVENTION

The present invention is directed to a multi-user mobile telephone station. The multi-user telephone station includes a handset having a key pad, a power-on switch, a display, and a controller coupled to the key pad and the display, a first memory location that stores a first feature set corresponding to a first user of the mobile telephone station, and a second memory location that stores a second feature set corresponding to a second user of the mobile telephone station. Upon powering-on of the handset, a log-in request is presented on the display, and, in response to the log-in request, the controller receives via the keypad a unique code that corresponds to one of at least the first user and the second user. In response to receipt of the unique code, the controller selects one of at least the first feature set or the second feature set and configures the mobile telephone station in accordance with the selected feature set. The handset is preferably a cellular telephone handset.

The present invention also includes a method of providing a multi-user mobile telephone station. The method includes providing a handset having a key pad and a power on switch, uniquely corresponding in at least one memory area of the handset a first feature set to a first user, and each of at least one secondary feature set to each additional user, activating by a user of a log-in display on the mobile station by powering on the handset, logging in by a user as a first user, as an additional user, or as an unknown user through the log-in display, and accessing by the user of the first feature set or the secondary feature set that uniquely corresponds to the user.

The present invention solves problems experienced with the prior art because the multi-use mobile telephone station avoids the necessity of getting separate telephones for each party that necessitates telephone access, while still providing a manner of tracking and preventing abuses of access to the telephone. The unique feature set for each user allows the user to engage in only authorized transactions during that user's access time. Further, each user can be granted access to additional features, unique to that user, that can expand the function of the telephone, such as an individualized phone book. Further, the method of the present invention allows a carrier to generate a monthly statement for a single telephone showing which user of the multi-use telephone made or received each call. Those and other advantages and benefits of the present invention will become apparent from the detailed description of the invention herein below.

### BRIEF DESCRIPTION OF THE SEVERAL VIEWS OF THE DRAWING

For the present invention to be clearly understood and readily practiced, the present invention will be described in conjunction with the following figures, wherein:

FIG. 1 is a front view illustrating a multi-user mobile telephone station; and

FIG. 2 is a flow diagram illustrating a method of providing a multi-use mobile telephone station.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in a typical mobile telephone system. Those of ordinary skill in the art will recognize that other elements are desirable and/or required in order to implement the present invention. However, because such elements are well known in the art, and because they do not facilitate a better understanding of the present invention, a discussion of such elements is not provided herein.

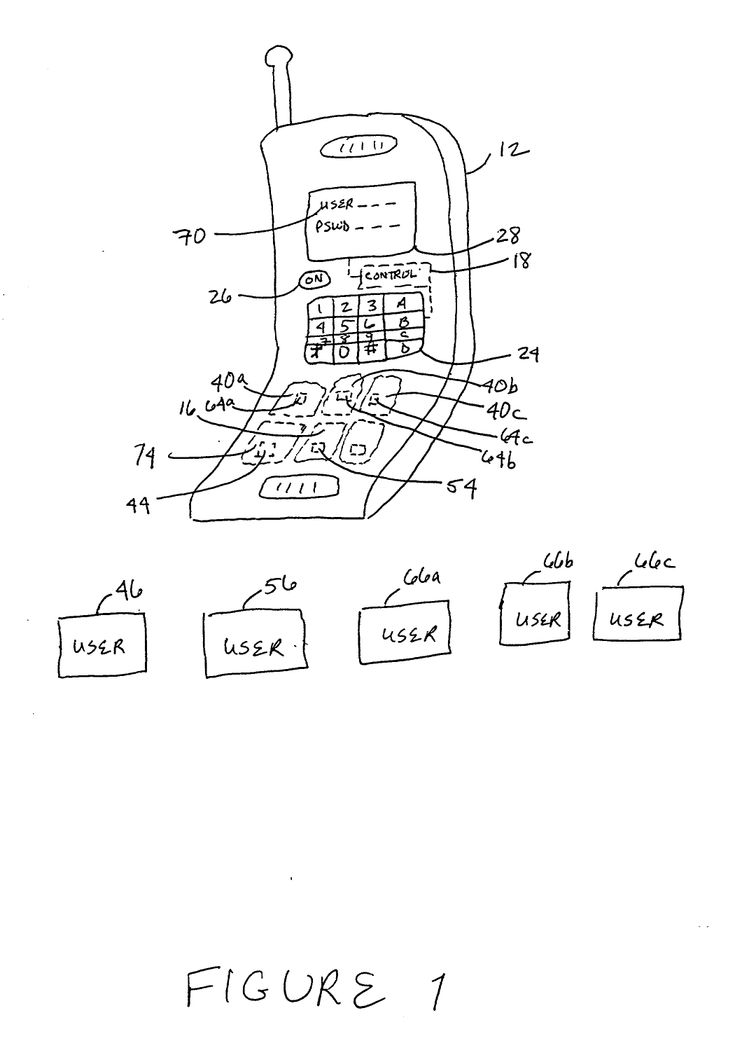

FIG. 1 is a front view illustrating a multi-user mobile telephone station 10. The multi-user mobile telephone station 10 includes a handset 12, a first memory location 14, a second memory location 16, and a controller 18 coupled to the first and second memory locations, and coupled to the handset.

The handset 12 is of the type generally known in the art, and may be, for example, a cellular telephone handset. The handset includes a key pad 24, a power-on switch 26, and a display 28. The controller 18 coupled to the key pad and the display.

The key pad 24 is a telephone key pad, such as those currently used in the art. The key pad 24 includes telephone numbered keys 0 through 9, and # and *. The key pad 24 may also include a plurality of alphabetic keys separate from the numeric keys. These alphabetic keys may include the letters A through Z, and may include combinations of two or more letters. The key pad 24 may include physical button keys, or may include touch sensitive keys displayed on a liquid crystal display screen, for example.

The power-on switch 26 may be any switch type used in the art that, when activated, provides power to or activates the telephone handset 12. The display 28 may be of any type used in small screen applications within the art, such as, but not limited to, a liquid crystal display, a light emitting diode display, or a cathode ray tube display.

The controller 18 is coupled to both the key pad 24 and the display 28. This coupling may be, for example, a wired electrical connection or a radiative connection. The controller 18 receives signals from the keypad 24, and causes responses on the display 28 and on the key pad 24 based on signals received from the key pad 24 and the first 14, second 16, or additional memory locations 40a, b, c, as is discussed further hereinbelow. The controller 18 may be, for example, a programmable logic controller or a central processing unit.

The first memory location 14 stores a first feature set 44 corresponding to a first user 46 of the mobile telephone station 10. The first user 46 may not be the first user in real time, but rather is designated as the first in order of memory location accorded. The first memory location 14 may be, for example, a cache, a RAM, or any other digital or analog device used in the art for storage purposes. The first memory location 14 may be externally coupled to the handset 12, or may be built into the handset 12. The first feature set 44 is a set of actions or records on the telephone 10 which may be available to the first user 46. The first feature set 44 is preferably selected from the group including a call timer log, which keeps a record of call lengths; a called number history log, which keeps a record of all numbers called; a phonebook, which keeps a list in memory of the first user's frequently called numbers; a list of allowed numbers, which keeps a record of numbers the first user is authorized to call; and a list of allowed area codes, which keeps a record of area codes that the first user is authorized to call to. More than one of the above-listed features, or additional features alone or in combination with those listed, may be included in the first feature set 44.

The second memory location 16 stores a second feature set 54 corresponding to a second user 56 of the mobile telephone station 10. The second user 56 may not be the second user in real time, but rather is designated as the second in order of memory location accorded. The second memory location 16 may be, for example, a cache, a RAM, or any other digital or analog device used in the art for storage purposes. The second memory location 16 may be externally coupled to the handset 12, or may be built into the handset. The second feature set 54 is a set of actions or records on the telephone 10 which may be available the second user 56. The second feature set 54 is preferably selected from the group including a call timer log, which keeps a record of call lengths; a called number history log, which keeps a record of all numbers called; a phonebook, which keeps a list in memory of the second user's frequently called numbers; a list of allowed numbers, which keeps a record of numbers the second user is authorized to call to; and a list of allowed area codes, which keeps a record of area codes that the second user is authorized to call to. More than one of the above-listed features, or additional features alone or in combination with those listed, may be included in the second feature set 54.

In one embodiment, a plurality of additional feature sets 64a, b, c are stored in a plurality of additional memory locations 40a, b, c. Each additional feature set 64a, b, c uniquely corresponds to one additional user 66a, b, c in the manner discussed hereinabove with respect to the first user 46 and second user 56. Each additional feature set 64a, b, c is also preferably selected from the group including a call timer log, a called number history log, a phonebook, a list of allowed numbers, and a list of allowed area codes, and may include additional features alone or in combination.

A log-in request 70 is presented on the display 28 of the handset 12 when the handset 12 is powered-on by the power switch 26. The log-in request 70 may be, for example, a request on the display 28 for a username or password, alone or in combination. In response to the log-in request 70, the user enters a log-in. The controller 18 receives via the key pad 24 the log-in code entered by the user, and that entered code is checked by the controller 18 against the unique codes that uniquely correspond to the first user 46, the second user 56, or an additional user 66a, b, c. The unique codes are preferably stored in the memory location which corresponds to each user, such as memory location 14 corresponds to user 46, for example, and may be alphabetic, numeric, or alpha-numeric. Where the log-in code matches one of the unique codes, the controller 18 logs the user in, granting access to the feature set in the memory location that corresponds to the user to whom the code uniquely corresponds. An incorrect log-in may cause the telephone 10 to power off automatically, or may renew the request for a log-in 70, for example.

The controller 18 selects one of the first feature set 44, the second feature set 54, or the additional feature set 64a, b, c from the entered user's memory location, and configures the mobile telephone station 10 in accordance with the selected feature set. This configuration corresponds to the at least one action or function in the feature set. For example, if the selected feature set entails a list of allowable area codes, the telephone will not dial a number when a user attempts to enter an area code not on the allowed list. This prevention of call completion may be performed, for example, by a prevention of entry of numbers not allowed on the list into the key pad 24. In this embodiment, the key pad 24 would be ignored by the controller 18 when a digit was entered in improper order, or was entered which was not allowed at all. Thus, if the only allowed area code was (555), but a 5 was entered followed by a 6, the controller 18 would ignore the 6, and all numbers entered other than 5 after the first 5 entered. This is done by methods known in the art, such as a discontinuance of signal to the incorrect keys on the key pad 24 by the controller 18. Other methods may be used to prevent entry of a non-allowed number, such as, but not limited to, not displaying an incorrectly entered number on the display 28, or powering off the telephone 10 if an incorrect number is entered.

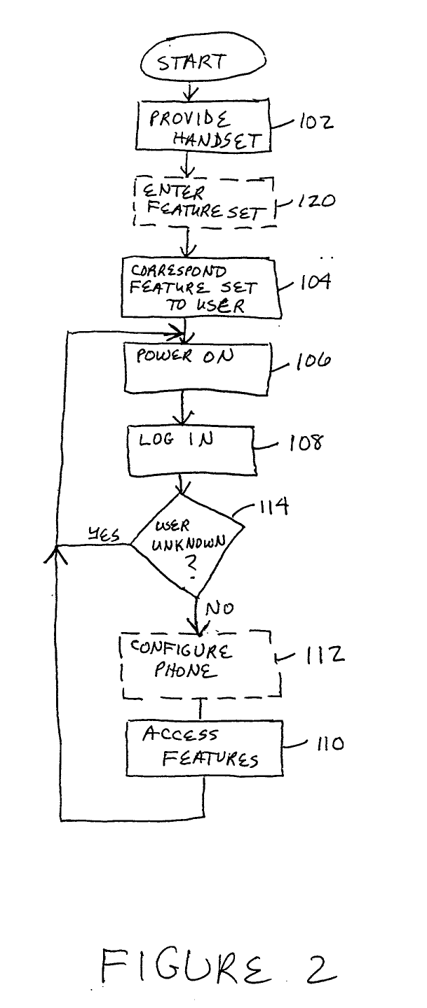

FIG. 2 is a flow diagram illustrating a method 100 of providing a multi-use mobile telephone station. The method 100 includes the step 102 of providing a handset having a key pad and a power on switch, the step 104 of uniquely corresponding in at least one memory area of the handset a first feature set to a first user, and each of at least one secondary feature set to each additional user, the step 106 of activating by a user of a log-in display on the mobile station by powering on the handset, the step 108 of logging in by the user as a first user or as an additional user through the log-in display, and the step 110 of accessing by the user of the first feature set or the secondary feature set that uniquely corresponds to the user. The method may also include the step 112 of configuring, by the controller, of the telephone in accordance with the selected feature set.

At step 108, the user logs in, substantially as discussed hereinabove with respect to FIG. 1, by entering at least one code to the key pad. The code may be numeric, alphabetic, or alpha-numeric. Entry of a code that does not correspond to the unique code in one of the memory locations that corresponds to a unique user may, for example, cause a powering-off of the telephone, or may cause a user to be returned to the log-in display, which returning is shown as step 114. If the code entered does uniquely correspond to a code in one of the memory locations, the user is logged in as a first user or a unique secondary user, and the controller selects the first feature set from the first memory location (if the first user code has been entered), or the unique secondary feature set from the additional memory location (if a secondary user code has been entered).

At step 110, the feature set that corresponds to the logged-in user is accessed by the user. The user has access only to the features available according to that user's feature set. Only these features are available because, in a preferred embodiment, the controller has configured, at step 112, the telephone to operate using only the feature set that corresponds to the user who has logged-in. The feature set is preferably selected from the group inclduing a call timer log, a called number history log, a phonebook, a list of allowed numbers, and a list of allowed area codes, and is selected according to the user entered, as discussed hereinabove.

The feature set to user correspondence may be entered at step 120. This step 120 of entering of the correspondence may be performed by the owner of the telephone, or by another party who is responsible for paying the bills associated with ownership of the telephone or ownership of the calling plan associated with the telephone. This step 120 of entering by the owner will occur where the feature set is to limit the function of the telephone, thereby allowing the owner to correspond certain features to certain users in order to minimize expenses associated with the telephone. The step 120 of entering by the owner would thus be used, for example, where the feature set includes a limited allowable area code list, as discussed hereinabove with respect to FIG. 1. The step 120 of entering the feature set may also be performed by the user with whom the feature set will correspond. Step 120 will occur in this manner where the function of the phone is to be expanded by a feature set, such as the presence of a push-button memory phone book, as discussed hereinabove with respect to FIG. 1.

Those of ordinary skill in the art will recognize that many modifications and variations of the present invention may be implemented. The foregoing description and the following claims are intended to cover all such modifications and variations.

What is claimed is:

1. A multi-user mobile telephone station, comprising:
a handset having a key pad, a power-on switch, a display, and a controller coupled to the key pad and the display;
a first memory location that stores a first feature set corresponding to a first user of the mobile telephone station, and a second memory location that stores a second feature set corresponding to a second user of the mobile telephone station, said first and second memory locations being coupled to the controller;
wherein, upon powering-on of said handset, a log-in request is presented on the display;
wherein, in response to the log-in request, the controller receives via the keypad a unique code that corresponds to one of at least the first user and the second user; and
wherein, in response to receipt of the unique code, the controller selects one of at least the first feature set or the second feature set and configures the mobile telephone station in accordance with the selected feature set.

2. The multi-user mobile telephone station of claim 1, wherein said handset is a cellular telephone handset.

3. The multi-user mobile telephone station of claim 1, wherein the key pad is a numeric telephone keypad.

4. The multi-user mobile telephone station of claim 3, wherein the keypad includes alphabetic keys separate from the numeric keys.

5. The multi-user mobile telephone station of claim 1, wherein the display is a liquid crystal display.

6. The multi-user mobile telephone station of claim 1, wherein the display is a light emitting diode display.

7. The multi-user mobile telephone station of claim 1, wherein the controller is a programmable logic controller.

8. The multi-user mobile telephone station of claim 1, wherein the controller is a central processing unit.

9. The multi-user mobile telephone station of claim 1, wherein the first feature set includes at least one feature selected from the group consisting of a call timer log, a called number history log, a phonebook, a list of allowed numbers, and a list of allowed area codes.

10. The multi-user mobile telephone station of claim 1, wherein the second feature set includes at least one feature selected from the group consisting of a call timer log, a called number history log, a phonebook, a list of allowed numbers, and a list of allowed area codes.

11. The multi-user mobile telephone station of claim 1, further comprising a plurality of additional feature sets stored in a plurality of additional memory locations, wherein each additional feature set uniquely corresponds to one additional user.

12. The multi-user mobile telephone station claim 11, wherein each additional feature set includes at least one feature selected from the group consisting of a call timer log, a called number history log, a phonebook, a list of allowed numbers, and a list of allowed area codes.

13. The multi-user mobile telephone station of claim 1, wherein the log-in request is a request for a username.

14. The multi-user mobile telephone station of claim 13, wherein the log-in request further includes a request for a password.

15. The multi-user mobile telephone station of claim 1, wherein the unique code is alphabetic.

16. The multi-user mobile telephone station of claim 1, wherein the unique code is numeric.

17. The multi-user mobile telephone station of claim 1, wherein the unique code is alpha-numeric.

18. The multi-user mobile telephone station of claim 1, wherein the unique code is a password.

19. The multi-user mobile telephone station of claim 1, wherein the display is a CRT.

20. A method of providing a multi-user mobile telephone station, comprising the steps of:
providing a handset having a key pad and a power on switch;
uniquely corresponding in at least one memory area of the handset a first feature set to a first user, and each of at least one secondary feature set to each additional user;
activating of a log-in display on the mobile station by powering on the handset;
logging in by a user as a first user, as an additional user, or as an unknown user through the log-in display; and
accessing of the first feature set or the secondary feature set that uniquely corresponds to the user in response to said logging in.

21. The method of claim 20, wherein said logging in comprises entering by the user of at least one unique code into the key pad.

22. The method of claim 20, further comprising selecting, by a controller, of one of at least the first feature set or the second feature set, based on said logging in.

23. The method of claim 22, further comprising configuring, by the controller, of the mobile telephone station in accordance with the selected feature set.

24. The method of claim 20, wherein the first feature set is selected from the group consisting of a call timer log, a called number history log, a phonebook, a list of allowed numbers, and a list of allowed area codes.

25. The method of claim 20, wherein each secondary feature set is selected from the group consisting of a call timer log, a called number history log, a phonebook, a list of allowed numbers, and a list of allowed area codes.

26. The method of claim 20, further comprising, upon a logging-in of a user as an unknown user, powering-off of the handset.

27. The method of claim 20, further comprising, upon a logging-in of a user as an unknown user, returning the display to the log-in display.

28. A multi-use mobile telephone station, comprising:
means for controlling functioning of the mobile telephone station;
a handset having means for entering codes to said handset, means for selectively providing power to said handset, and a display, wherein said means for controlling is coupled to said means for entering codes and said means for selectively providing power;
means for storing a first feature set corresponding to a first user of the mobile telephone station, and means for storing a second feature set corresponding to a second user of the mobile telephone station, said means for storing a first feature set and means for storing a second feature set being coupled to said means for controlling;
wherein, upon powering-on of said handset, a log-in request is presented on the display; wherein, in response to the log-in request, said means for controlling receives via the means for entering a code a unique code that corresponds to one of at least the first user and the second user; and
wherein, in response to receipt of the unique code, said means for controlling selects one of at least the first feature set or the second feature set and configures the mobile telephone station in accordance with the selected feature set.
